(19) United States
(12) Patent Application Publication
(10) Pub. No.: US 2016/0263950 A1
(43) Pub. Date: Sep. 15, 2016

(54) TIRE HEALTH MONITORING SYSTEM

(71) Applicant: Caterpillar Inc., Peoria, IL (US)

(72) Inventors: David J. Colantoni, Metamora, IL (US); Adam L. Ofisher, Elk Grove Village, IL (US); Matthew J. Hess, Aurora, IL (US)

(73) Assignee: Caterpillar Inc., Peoria, IL (US)

(21) Appl. No.: 15/163,141

(22) Filed: May 24, 2016

(51) Int. Cl. B60C 23/04

(52) U.S. Cl. CPC B60C 23/0408

(57) ABSTRACT

A system for monitoring health of a tire of a machine is provided. The system includes a plurality of sensors associated with the tire and provided on-board the machine. Each of the sensors is configured to generate a signal indicative of an operational parameter of the tire. A health module is communicably coupled to the sensors and is configured to receive the signal indicative of the operational parameter of the tire. The health module is configured to correlate the operational parameter with machine data associated with the machine and computes an expected time of removal of the tire based on the correlation. The health module is configured to determine a corrective action associated with operating the machine for extending a life of the tire beyond the computed expected time of removal. The health module is configured to notify an operator of the determined corrective action.

### TECHNICAL FIELD

The present disclosure relates to monitoring of machines, and more specifically, to health monitoring of tires of the machines.

### BACKGROUND

Tires are an integral component of machines. Tires are employed in different types of machines such as, but not limited to, articulated trucks, wheel loader, and wheel dozer, for performing various operations. Depending on the working conditions faced during operation of the machine, the tires may suffer from various health issues such as, but not limited to, loss of pressure in the tires, and/or damaged tread patterns of the tires. Such health issues of the tires may result in considerable downtime of the machine.

Currently, in order to identify the health issues of the tires, a number of techniques such as, for example, a manual inspection of the tires or monitoring of the tires using sensors and controllers may be used. Such techniques may alert a user of various health issues of the tires. However, such techniques may be utilized when the tires are already close too or in a worn out condition and/or when the tires may be permanently damaged. Also, such techniques may not provide any mechanism to the user to avoid tire failure prior to damage or to enhance tire life.

U.S. Pat. No. 5,809,437 describes a component diagnostic system for a motor vehicle. The component diagnostic system includes at least one component which emits a signal. The signal includes a pattern containing information to determine whether the component is operating normally or abnormally. The system includes at least one sensor which senses the signal and converts the signal into electrical signal corresponding to the pattern. The system further includes a processor coupled to the sensor for processing the electrical signal to determine if the pattern of the electrical signal corresponds to an abnormal state of an operation of the component. An output device is coupled to the processor for affecting another system within the vehicle if the component is operating abnormally. The processor preferably includes the capability of pattern recognition.

However, known systems may not provide any mechanism for informing the user in advance of abnormal state of the tire and/or improving health of the tire. Therefore, there is a need for an improved tire health monitoring system.

### SUMMARY OF THE DISCLOSURE

In one aspect of the present disclosure, a system for monitoring health of a tire of a vehicle is provided. The system includes a plurality of sensors associated with the tire and provided on-board the machine. Each of the plurality of sensors is configured to generate a signal indicative of an operational parameter of the tire. A health module is communicably coupled to the plurality of sensors. The health module is configured to receive the signal indicative of the operational parameter of the tire. The health module is further configured to correlate the operational parameter with machine data associated with the machine. The health module is configured to compute an expected time of removal of the tire based, at least in part, on the correlation. Further, the health module is configured to determine a corrective action associated with operating the machine for extending a life of the tire beyond the computed expected time of removal. The health module is configured to notify an operator of the determined corrective action.

Other features and aspects of this disclosure will be apparent from the following description and the accompanying drawings.

### BRIEF DESCRIPTION OF THE DRAWINGS

FIG. 1 is a perspective view of an exemplary machine, in accordance with the concepts of the present disclosure;

FIG. 2 is a block diagram of a system for monitoring health of a tire of the machine of FIG. 1, in accordance with the concepts of the present disclosure; and

FIG. 3 is an exemplary user interface generated by the system, in accordance with the concepts of the present disclosure.

### DETAILED DESCRIPTION

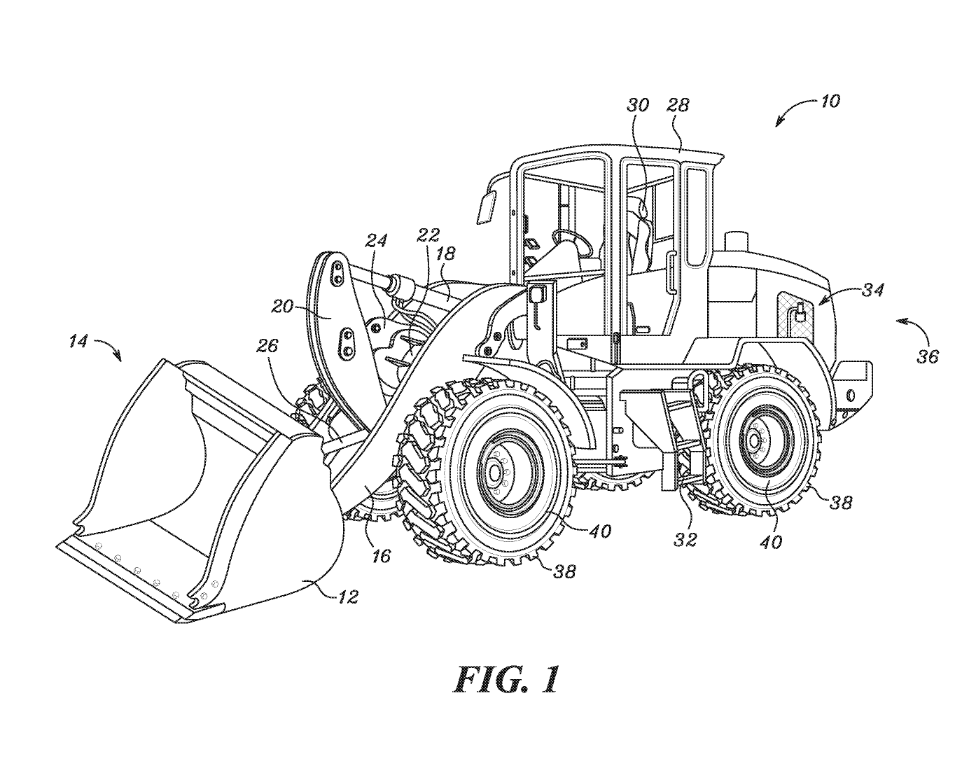

Referring to FIG. 1, an exemplary machine 10 is illustrated. The machine 10 is used for various operations such as, but not limited to, grading of land, or loading and transportation of materials. The machine 10 includes a bucket 12 which is disposed at a first end 14 of the machine 10. The bucket 12 is utilized for loading the materials. It should be noted that the height of the bucket 12 is varied by varying height of booms 16. Further, the orientation of the bucket 12 is varied by retracting and expanding length of a hydraulic cylinder 18. The hydraulic cylinder 18 is coupled to a bucket bellcrank 20. The bucket bellcrank 20 is pivotally coupled to a bar 22 which is disposed between the booms 16, using a joint member 24. Further, the bucket bellcrank 20 is coupled to a linkage 26, and oscillates around the joint member 24 to change the orientation of the bucket 12 with the help of the linkage 26.

The machine 10 further includes an operator cab 28 which has a driver seat 30 for an operator to be seated. The operator cab 28 is accessed by steps 32. Further, the machine 10 includes an engine assembly 34 which is disposed at a second end 36 of the machine 10. The engine assembly 34 includes an engine (not shown) which is configured to provide power to the machine 10. Further, the machine 10 includes a number of tires 38 and a number of rims 40. The tires 38 have a predetermined temperature and pressure. Further, the tires 38 include a tread pattern adapted to provide grip between ground and the tire 38 of the machine 10 during the operation of the machine 10. The machine 10 further includes various other components such as, but not limited to, mirrors, a number of lights, windows, or a steering wheel. For the purpose of simplicity, the various other components of the machine 10 are not labeled in FIG. 1. It will be apparent to one skilled in the art that the machine 10 shown in FIG. 1 is a wheel loader. However, the machine 10 may be any other wheeled machine including, but not limited to, a wheel dozer, or articulated trucks, without departing from the scope of the disclosure.

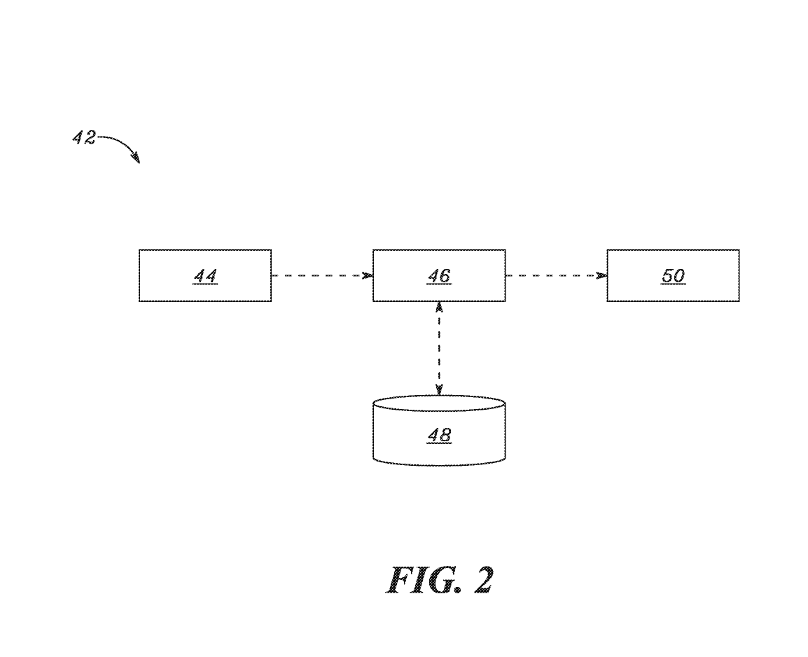

Referring to FIG. 2, a system 42 includes a number of sensors 44 which are associated with the tire 38 and provided on-board the machine 10. It should be noted that the sensors 44 are disposed on the rim 40 of the tire 38. Alternatively, the sensors 44 may be disposed at another location such as a chassis of the machine 10, an axle of the tire 38, and so on. Each one of the sensors 44 is configured to generate a signal indicative of an operational parameter of the tire 38. The operational parameter of the tire 38 include, but are not limited to, temperature of the tire 38, pressure of the tire 38, and/or speed of the tire 38. It will be apparent to one skilled in the art that the operational parameter mentioned above has been provided only for explanation purposes, without departing from the scope of the disclosure. Further, examples of the sensors 44 include a wheel speed sensor, a temperature sensor, and/or a pressure sensor. The number of the sensors 44 may vary based on the number of the tires 38, such that the operational parameter of each tire 38 may be sensed by the sensors 44.

A health module 46 is communicably coupled to the sensors 44 and is configured to receive the signal indicative of the operational parameter of the tire 38, from each of the sensors 44 associated with the tire 38. After receiving the operational parameter, the health module 46 is configured to correlate the operational parameter of the tire 38 with machine data associated with the machine 10. The machine data is monitored and obtained via sensors (not shown) associated with various components of the machine 10 such as, but not limited to, the bucket 12, the hydraulic cylinder 18, the operator cab 28, or the engine assembly 34. It should be noted that the machine data may be obtained from reports or any other external source or repository associated with the machine 10, without departing from the scope of the disclosure. The machine data includes, but not limited to, a position of a steering wheel, torque generated by the engine, a fuel level, charge in batteries, brake conditions, wear out condition of shock absorbers, an engine temperature, and a temperature of a radiator.

As an example, the correlation is performed by mapping the operational parameter of the tire 38 with pre-stored machine data stored in a database 48. The database 48 is communicably coupled to the health module 46 and stores the operational data of the tire 38 and/or the machine data associated with the machine 10. In another embodiment, the correlation is performed using a predefined set of rules. The predefined set of rules includes, but not limited to, a correlation between the pressure of the tire 38 and the speed of the machine 10, a correlation between the pressure of the tire 38 and a load on the machine 10, a correlation between the temperature of the tire 38 and the speed of the machine 10, or a correlation between the tread depth of the tire 38 and the acceleration of the machine 10.

In one embodiment, the correlation may also be a mathematical relationship or equation between the defined operational parameters. It will be apparent to one skilled in the art that the machine data and the predefined set of rules mentioned above are provided only for explanation purposes, without departing from the scope of the disclosure. The correlation between the sensory information associated with the tire 38 and the machine data may he predefined or updated on a real-time basis to denote an effect of a method of operating the machine 10 and/or the machine data on the operational parameter of the tire 38 over time. Further, by correlating the sensory information and the machine data, the health module 46 may determine whether the operator is operating the tire 38 at a level or in a manner that may result in the optimal performance or lowest cost per hour for the operator of the machine 10.

The health module 46 is configured to compute an expected time of removal of the tire 38 based on the correlation. The expected time of removal of the tire 38 corresponds to an end of service life of the tire 38. As an example, the expected time of removal of the tire 38 may be computed as 10 days based on the correlation of the operational parameter, such as pressure within the tire 38, and the machine data, such as the speed of the machine 10. Moreover, considering a current method of operation of the machine 10 by the operator, as indicated by the sensory information associated with the tires 38 and the machine data associated with overall functioning of the machine 10, the expected time of removal determined by the health module 46 provides an indication to the operator of the expected end of the service life of the tire 38.

After computing the expected time of removal of the tire 38, the health module 46 determines a corrective action associated with operating the machine 10 to extend the life of the tire 38. If the operator abides by the corrective action, the life of the tire 38 may be extended beyond the computed expected time of the removal of the tire 38. As an example, if the pressure within the tire 38 is less than a threshold value, then the corrective action includes, but not limited to, controlling the speed of the machine 10 or reducing the load on the machine 10 in order to extend the life of the tire 38. If the operator does not abide by the corrective action, then the service life of the tire 38 may end at or close to the expected time of the removal of the tire 38. It will be apparent to one skilled in the art that the corrective action mentioned above is provided only for explanation purposes, without departing from the scope of the disclosure.

The health module 46 is further communicably coupled to an output module 50. The output module 50 is configured to notify an operator of the expected time of removal of the tire 38 and/or the determined corrective action. As an example, the output module 50 notifies the operator of the corrective action by displaying the corrective action on devices such as, but not limited to, a personal computer, a mobile, a television, a pager, a display device, or a tablet. Alternatively, the output module 50 may notify the operator of the corrective action via an audio output or any other combination of a visual and auditory output.

As an example, the health module 46 receives the operational parameter associated with the tire 38 such as, the temperature of the tire 38 as 60 degree Celsius, from the sensors 44. Based on the received operational parameter, the health module 46 correlates the temperature within the tire 38 with the machine data. The machine data includes that the machine 10 is moving at 60 km/hr. Based on the correlation, the health module 46 computes the expected time of removal of the tire 38 as 10 days. Further, the health module 46 determines the corrective action including controlling the speed of the machine 10 from 60 km/hr to 45 km/hr in order to extend the life of the tire 38 from 10 to 16 days. Thereafter, the health module 46 notifies the operator of the determined corrective action.

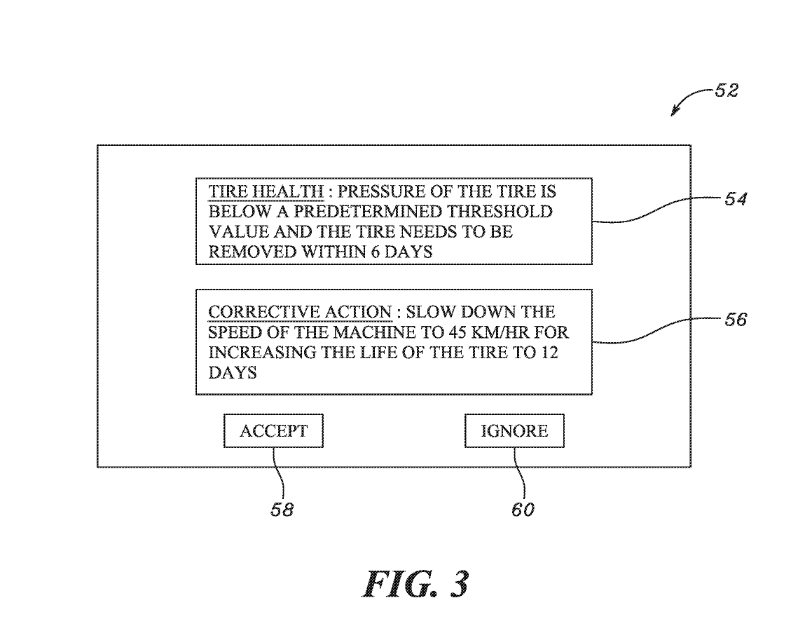

Referring to FIG. 3, an exemplary user interface 52 of the output module 50 is illustrated. The user interface 52 is utilized for notifying the operator of the determined corrective action. The user interface 52 may be displayed on a monitor within the operator cab 28 of the machine 10. Further, the user interface 52 includes a first section 54 and a second section 56. The first section 54 includes the operational parameter associated with the tire 38 and expected time of removal of the tire 38.

As illustrated, the first section 54 indicates to the operator that the pressure of the tire 38 of the machine 10 is below a predetermined threshold value and the tire 38 needs to be removed within 6 days. Further, the second section 56 includes the corrective action for the operation of the machine 10 to increase the life of the tire 38 beyond the expected time of the removal of the tire 38. As illustrated, the second section 56 indicates that the corrective action is to slow down the speed of the machine 10 to 45 km/hr for increasing the life of the tire 38 to 12 days. The user interface 52 further includes a first button 58 and a second button 60. The first button 58 is configured to allow the operator to accept the corrective action. Similarly, the second button 60 is configured to allow the operator to ignore the corrective action.

The user interface 52 including the expected time of removal of the tire 38 and the corrective action provided in the accompanying figures is merely on an exemplary basis and does not limit the scope of the disclosure. The values provided may change based on the sensory information and the machine data. Further, the appearance of the user interface 52 may vary based on the application.

### INDUSTRIAL APPLICABILITY

The present disclosure provides the system 42 for monitoring the health of the tire 38 of the machine 10. The system 42 is an automatic system that identifies and measures the usage of the tire 38 of the machine 10 to extend the life of the tire 38. The system 42 computes the expected time of removal of the tire 38, based on the operations of the machine 10. Based on the computed expected time of removal of the tire 38, the system 42 further determines the corrective action associated with the operations of the machine 10 for extending the life of the tire 38 beyond the computed expected time of removal. Thereafter, the system 42 notifies the operator of the corrective action, and therefore, provides the operator opportunity to change the operations of the machine 10 in order to extend the life of the tire 38.

Additionally, the system 42 predicts the failure of the tire 38 before the failure occurs so that the life of the tire 38 may be extended. Also the system 42 prevents the likelihood of a sudden tire 38 failure, reducing unnecessary downtime of the machine 10. The system 42 also enables cost savings, by determining whether the operator is operating the tire 38 at a level or in a manner that may result in the optimal performance for the tire 38 or lowest cost per hour for the operator of the machine 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for monitoring health of a tire of a machine, the system comprising:
a plurality of sensors associated with the tire and provided on-board the machine, each of the plurality of sensors configured to generate a signal indicative of an operational parameter of the tire; and
a health module communicably coupled to the plurality of sensors, the health module configured to:
receive the signal indicative of the operational parameter of the tire;
correlate the operational parameter with machine data associated with the machine;
compute an expected time of removal of the tire based, at least in part, on the correlation;
determine a corrective action associated with operating the machine for extending a life of the tire beyond the computed expected time of removal; and
notify an operator of the determined corrective action.
